(19) United States
(12) Patent Application Publication
(10) Pub. No.: US 2007/0008381 A1
(43) Pub. Date: Jan. 11, 2007

(54) Thermal print head with temperature control function

(76) Inventors: Chung-Yi Cheng, Taichung (TW); Yi-Chieh Chen, Taichung County (TW)

Correspondence Address: HARNESS, DICKEY & PIERCE, P.L.C., P.O. BOX 8910, RESTON, VA, 20195, US

(21) Appl. No.: 11/271,733

(22) Filed: Nov. 14, 2005

(30) Foreign Application Priority Data
Jul. 8, 2005 (TW) 94123297

(51) Int. Cl. B41J 2/05

(52) U.S. Cl. 347/61

(57) ABSTRACT

A thermal print head with the temperature control function includes a print head module installed with a first temperature sensor thereon to measure the temperature of the print head module, a heat sink installed on the print head module, a heat dissipating module installed with more than one second temperature sensors to measure the temperature thereof, and a controller for adjusting the heating method of the print head module according to the temperatures measured at the print head module and the heat dissipating module.

### CROSS-REFERENCE TO RELATED APPLICATIONS

This non-provisional application claims priority under 35 U.S.C. § 119(a) on Patent Application No(s). 94123297 filed in Taiwan, R.O.C. on Jul. 8, 2005, the entire contents of which are hereby incorporated by reference.

### BACKGROUND

1. Field of Invention

The invention relates to a thermal print head and, in particular, to a thermal print head with the temperature control function.

2. Related Art

A usual thermal printer includes a linear array of heating elements (or called the print head elements) to transfer desired colors from a ribbon to an output medium or to activate the color forming mechanism on an output medium. A typical output medium is a porous material that receives color transfers or a piece of paper coated with a chemical that can form colors. When the output medium passes under the heating elements, the heating elements form the desired colors on the output medium. The heating elements activate the colors by providing energy. The temperature of the heating elements increases for the colors on the ribbon to be transferred onto the output medium or for the color forming mechanism on the output medium to start forming colors. The energy provided by the heating elements varies with the density of the colors and the temperature on the print head.

Since the temperature of the heating elements has a great impact on the reproducibility and density of colors. During the process of printing, they are likely to accumulate the heat. Therefore, it is a key to good quality of the thermal printer if one is able to accurately detect the temperature of the heating elements for proper energy control. In accord to the current technology, it is very difficult to accurately measure the temperature of the heating elements (print head elements). FIG. 1 shows a system disclosed in U.S. Pat. No. 6,819,347. The print head includes several layers, including a heat sink 3, ceramic 5, and glaze 7. The temperature of the heating elements 9a to 9g are not measured directly but indirectly instead. It provides a temperature model for the print head. The temperature of the environment around the heating elements and the history of energy transfer to the print head are used to predict the needed temperature on the heating elements 9a to 9g. The ambient temperature is measured by the temperature sensor 1 installed on the heat sink 3.

It is thus seen that how to accurately measure and control the temperature of the heating elements is extremely difficult. Therefore, it is imperative to provide a method that can rapidly dissipate the heat generated by the heating elements. With an appropriate temperature measuring method, the temperature of the heating elements will be better controlled.

### SUMMARY

In view of the foregoing, the invention provides a thermal print head with the temperature control function. It avoids the accumulation of heat on the heat sink and the heating elements (print head elements) and provides more appropriate temperature measuring data. The temperature control of the heating elements prevents color distortion and improves the printing quality. Besides, since the possible temperature of the heating elements during printing can be accurately measured, the invention can achieve better energy modulation efficiency for the heating elements to save energy. Moreover, once the provided energy can be accurately controlled with the more accurately measured temperature of the heating elements, the heat dissipation is reduced and the cooling module can be further shrunk in size to minimize the volume of the entire system.

The disclosed thermal print head includes: a print head module; a first temperature sensor installed above the print head module for measuring the temperature thereof; a heat sink installed above the print head module; a heat dissipating module installed above the heat sink; a second temperature sensor installed above the heat dissipating module for measuring the temperature thereof; and a controller for adjusting the heating method of the print head module according to the temperature of the print head module and the heat dissipating module.

The print head module may include a plurality of heating elements controlled by the controller to heat the print head module.

The heat dissipating module may be installed with a plurality of temperature sensors to measure the temperature thereof.

On the other hand, one thermal print head with the temperature control function disclosed by the invention includes: a print head module; a first temperature sensor installed above the print head module for measuring the temperature thereof; a heat sink connected to the print head module; a heat dissipating module connected to the heat sink; a plurality of second temperature sensors distributed evenly above the heat dissipating module for measuring the temperature thereof; and a controller for adjusting the heating method of the print head module according to the temperature of the print head module and the heat dissipating module.

The heat dissipating module in the above embodiments may further include a cooling module to accelerate the heat dissipating speed of the heat dissipating module. The cooling module is a fan or a cooling pipeline with a flowing coolant.

The heat dissipating module has a ladder structure to increase its dissipation. In addition, the temperature sensor is installed on a slant or planar surface of the ladder structure and can be adjusted according to the sensed effect.

In summary, the heat dissipating module with temperature sensors provided in the temperature control system of the disclosed thermal print head can indeed prevent heat accumulation on the print head and the heat sink. Therefore, the cooling efficiency of the heat dissipating module with temperature sensors and the heat sink is not reduced. With more accurately measured temperature data, the temperature of the print head can be more accurately measured for a better printing quality.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow illustration only, and thus are not limitative of the present invention, and wherein:

FIG. 1 shows the thermal printer system disclosed in U.S. Pat. No. 6,819,347;

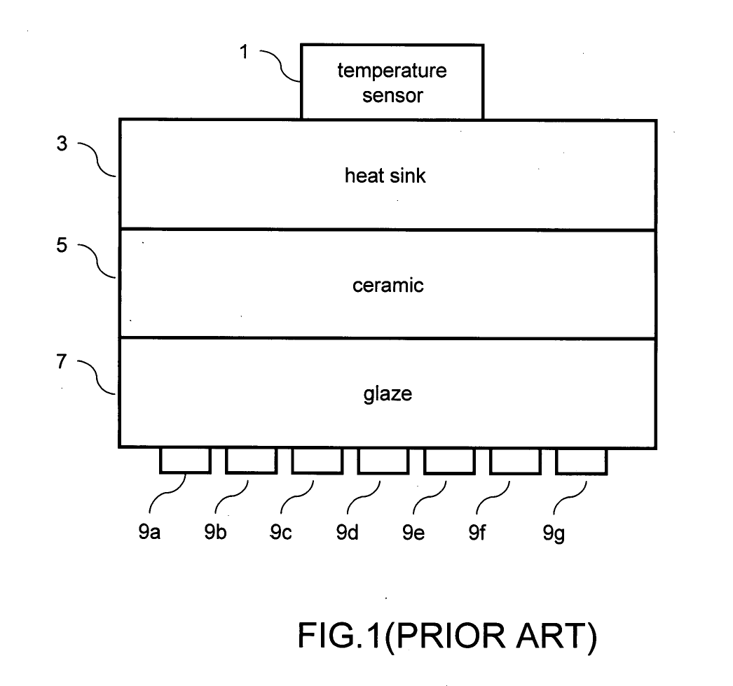

FIGS. 2A and 2B are three-dimensional and side views of the disclosed thermal print head with the temperature control function according to a preferred embodiment of the invention; and

FIG. 3 is a schematic view of the structure of the disclosed thermal print head with the temperature control function.

### DETAILED DESCRIPTION

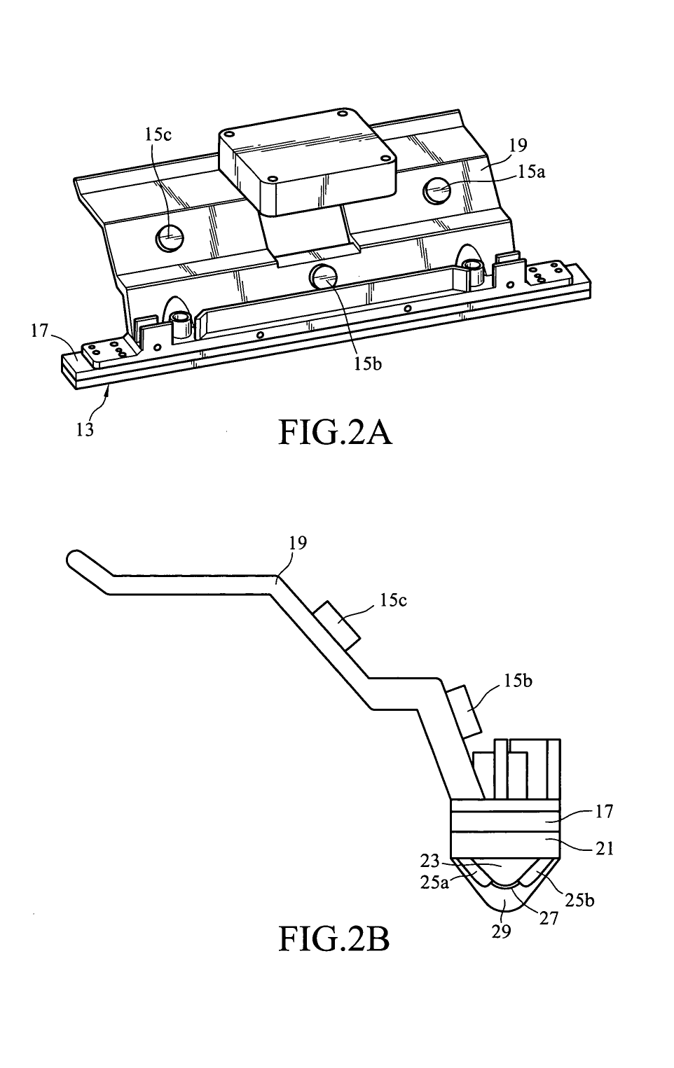

Please refer to FIGS. 2A and 2B for three-dimensional and side views of the thermal print head with the temperature control function according to a preferred embodiment of the invention.

The thermal print head includes: a print head module 13, a heat sink 17, and a heat dissipating module 19.

The print head module 13 includes a ceramic substrate 21, a glaze layer 23, electrodes 25a, 25b, heating elements 27, and a protective layer 29.

The heat sink 17 is coupled to the ceramic substrate 21. The glaze layer 23 is provided below the ceramic substrate 21.

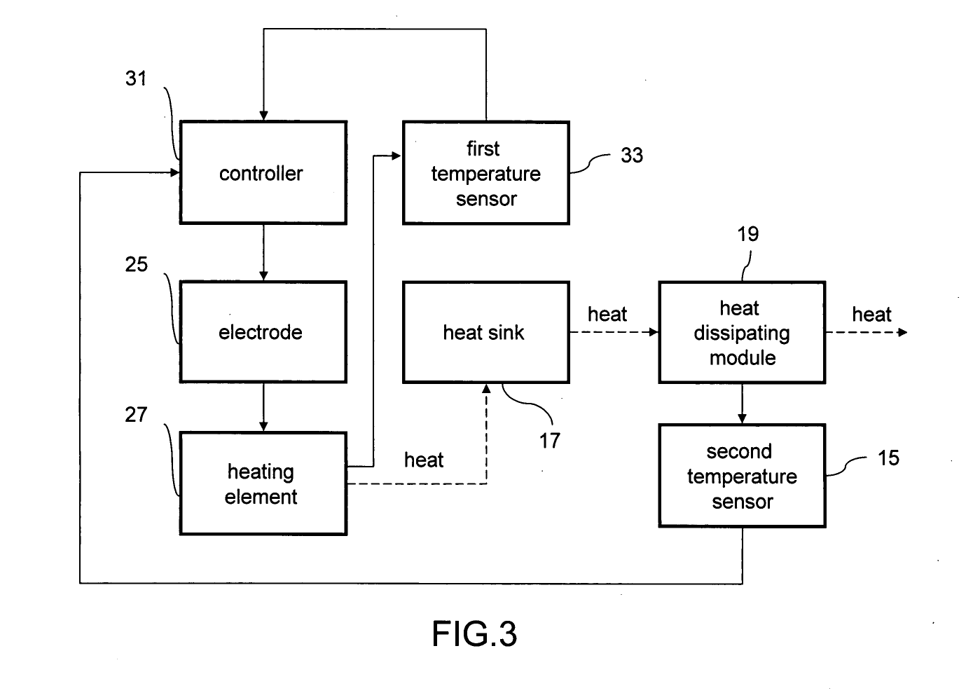

Several heating elements 27 and the electrodes 25a, 25b for providing energy to the heating elements 27 are installed below the glaze layer 23, and the heating elements 27 are disposed in a linear array. The temperature of heating elements are normally measured using a first temperature sensor 33 (FIG. 3) installed at the heat sink 17.

It should be understood that even though only one heating element is explicitly shown in the drawing, there may actually be hundreds or thousands of heating elements disposed densely in unit length.

As described above, the electrodes 25a, 25b can provide energy to the heating elements 27 for heating up to a specific temperature, thereby transferring colors to an output medium. The heat produced by the heating elements 27 passes through the glaze layer 23, the ceramic substrate 21, up to the heat sink 17. The temperature data of the heating elements 27 is directly sent to the controller 31 by the first temperature sensor 33 thereon (shown in FIG. 3). The power of the heating elements 27 is then adjusted according to the specific temperature.

When the above system is printing, the heating elements 27 continuously generate heat. If the heat sink 17 can not dissipate the heat in time, the working efficiency of the entire print head module 13 will be affected because the print head has a specific working temperature range. Moreover, the accuracy of temperature measurement and thus the precision in the feedback temperature control of the print head module 13 will be affected too.

Therefore, the heat sink 17 according to the invention is added with a heat dissipating module 19, which is used to rapidly dissipate heat thereon. Besides, the second temperature sensors 15a, 15b, 15c on the heat dissipating module 19 can also measure the temperature of the heat dissipating module 19, thereby adjusting the heating method of the print head module 13. The heat dissipating module 19 is installed with more than one second temperature sensor 15a, 15b, and 15c for measuring the temperature of the heat dissipating module 19. The measured temperature data are passed to the controller 31 (shown on FIG. 3), and the controller 31 will calculate the measured temperature with the temperature obtained from the first temperature sensor 33 to proceed the temperature control and heating adjustment for the print head module 13, the heating elements 27, or the heat dissipating module 19.

There are many methods for temperature control. For example, a cooling module (not shown in the drawing) can be installed on the heat dissipating module 19. The cooling module may be a fan or a cooling pipeline with a flowing coolant.

With the combination of the heat dissipating module 19 and the heat sink 17, the heat generated by the heating elements 27 can be dissipated by the heat sink 17, and then the heat dissipating module 19. Therefore, no heat is accumulated at the heat sink 17. By monitoring the temperature of the heat dissipating module 19, the temperature of the heat dissipating module 19 can be also controlled. Therefore, the heat dissipating module 19 wouldn't have the problem of heat accumulating. Using the invention, the heat generated by the heating elements 27 can be immediately removed. The temperature measured by the first temperature sensor 33 (FIG. 3) is thus more accurate. With the more accurately measured temperature data, the temperature of the print head module 13 or the heating elements 27 can be accurately controlled.

To be more explicit, the temperature measured by the second temperature sensors 15a, 15b, 15c and the temperature measured by the first temperature sensor 33 (FIG. 3) are processed by the controller 31 (FIG. 3) to obtain a better power control of the heating elements 27. The printing quality is thus guaranteed with the temperature control of the print head according to the invention.

On the other hand, the heat dissipating module 19 can have a ladder structure for enhancing its heat dissipation. The second temperature sensors 15a, 15b, 15c are installed on the slant or planar surface of the ladder structure. These can be adjusted according to the sensing effects achieved in practice.

With reference to FIG. 3, the heat generated by the heating elements 27 is transferred to the heat sink 17, and the heat on the heat sink 17 is then transferred to the heat dissipating module 19. The temperature data obtained from the second temperature sensor 15 of the heat dissipating module 19 and from the first temperature sensor 33 are sent to the controller 31 for calculations to obtain a feedback control signal. The feedback control signal controls the power provided by the electrodes 25 to the heating elements 27 or the power for maintaining a specific temperature.

In conclusion, it is seen that the invention can prevent the heating elements in the print head module and the heat sink installed on the print head module from heat accumulation. The temperature of the print head module or heating elements can be more accurately measured and controlled. Since the heat dissipating module of the invention has second temperature sensors, they can provide temperature data to control its temperature. Therefore, it doesn't have to worry about the overheating phenomena occurring to the heat dissipating module or the coupled heat sink. In other words, the cooling efficiency is not reduced.

Using the invention, the possible temperature of the print head during printing can be more accurately measured. Therefore, the energy modulation efficiency of the print head can be accurately adjusted to save the energy. Since the energy is controlled and provided according to the temperature more accurately measured at the print head, the required heat dissipation can be reduced. The cooling module can be reduced to further shrink the volume of the entire system.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A thermal print head with the temperature control function, comprising:
a print head module;
a first temperature sensor installed at the print head module for measuring the temperature thereof;
a heat sink installed on the print head module;
a heat dissipating module installed on the heat sink;
a second temperature sensor installed at the heat dissipating module for measuring the temperature thereof; and
a controller for adjusting the heating method of the print head module according to the temperature of the print head module and the heat dissipating module.

2. The thermal print head with the temperature control function of claim 1, wherein the print head module includes a plurality of heating elements controlled by the controller to proceed heating for the print head module.

3. The thermal print head with the temperature control function of claim 1, wherein the heat dissipating module is installed with a plurality of second temperature sensors for measuring the temperature of the heat dissipating module.

4. The thermal print head with the temperature control function of claim 1, wherein the heat dissipating module further includes a cooling module.

5. The thermal print head with the temperature control function of claim 4, wherein the cooling module is a fan.

6. The thermal print head with the temperature control function of claim 4, wherein the cooling module is a cooling pipeline with a flowing coolant.

7. The thermal print head with the temperature control function of claim 1, wherein the heat dissipating module is a ladder structure.

8. The thermal print head with the temperature control function of claim 7, wherein the second temperature sensor is installed on a slant surface of the ladder structure.

9. The thermal print head with the temperature control function of claim 7, wherein the second temperature sensor is installed on a planar surface of the ladder structure.

10. A thermal print head with the temperature control function, comprising:
a print head module;
a first temperature sensor installed at the print head module for measuring the temperature thereof;
a heat sink coupled to the print head module;
a heat dissipating module coupled to the heat sink;
a plurality of second temperature sensors evenly distributed on the heat dissipating module for measuring the temperature thereof; and
a controller coupled to the first temperature sensor and the second temperature sensors for adjusting the heating method of the print head module according to the temperature of the print head module and the heat dissipating module.

11. The thermal print head with the temperature control function of claim 10, wherein the heat dissipating module further includes a cooling module.

12. The thermal print head with the temperature control function of claim 11, wherein the cooling module is a fan.

13. The thermal print head with the temperature control function of claim 11, wherein the cooling module is a cooling pipeline with a flowing coolant.

14. The thermal print head with the temperature control function of claim 10, wherein the heat dissipating module is a ladder structure.

15. The thermal print head with the temperature control function of claim 14, wherein the plurality of second temperature sensors is installed on a slant surface of the ladder structure.

16. The thermal print head with the temperature control function of claim 14, wherein the plurality of second temperature sensors is installed on a planar surface of the ladder structure.
